(19) United States
(12) Patent Application Publication
(10) Pub. No.: US 2026/0079253 A1
(43) Pub. Date: Mar. 19, 2026

(54) RECONFIGURABLE DETECTION WINDOWS WITH DYNAMICALLY ACTIVATED DETECTION ARRAYS

(71) Applicant: Banner Engineering Corp., Minneapolis, MN (US)

(72) Inventors: Charles Dolezalek, Blaine, MN (US); William Theunissen, Minneapolis, MN (US); Abdi Amaro, Minneapolis, MN (US)

(73) Assignee: Banner Engineering Corp., Minneapolis, MN (US)

(21) Appl. No.: 19/109,068

(22) PCT Filed: Sep. 26, 2023
(86) PCT No.: PCT/US2023/075143

§ 371 Date: Mar. 5, 2025

Related U.S. Application Data
(60) Provisional application No. 63/377,301, filed on Sep. 27, 2022.

(51) Int. Cl. G01S 17/08

(52) U.S. Cl. CPC G01S 17/08

(57) ABSTRACT

Apparatus and associated methods relate to generate a mapping between reconfigurable predetermined detection windows (RPDWs) and sensing elements across adjacent distance sensing arrays. In an illustrative example, two or more adjacently placed distance sensing arrays may each include sensor elements coupled to uniquely and physically addressable memory registers. A master controller coupled to the distance sensing arrays may, for example, receive a signal to set up a virtual address mapping for a RPDW. For example, the RPDW may associate adjacent distance sensing elements across the two distance sensing arrays. The master controller may, for example, identify activated registers during a teaching operation to generate a mapping between the RPDW and the identified range of activated registers. When the RPDW is monitored, only the registers associated with the virtual address may, for example, be activated to be monitored. Various embodiments may advantageously reduce time and resources for monitoring the RPDW.

### CROSS-REFERENCE TO RELATED APPLICATIONS

This application claims the benefit of U.S. Provisional Application Ser. No. 63/377,301, titled “Reconfigurable Detection Windows with Dynamically Activated Detection Arrays,” filed by Charles Dolezalek, et al., on Sep. 27, 2022.

This application incorporates the entire contents of the foregoing application(s) herein by reference.

The subject matter of this application may have common inventorship with and/or may be related to the subject matter of:
U.S. application Ser. No. 17/153,691, titled “DISTANCE SENSING AND VISUAL INDICATOR ARRAYS WITH RECONFIGURABLE DETECTION WINDOWS,” filed by Charles Dolezalek on Jan. 20, 2021;
PCT Application Serial No. PCT/US2022/070108, titled “DISTANCE SENSING AND VISUAL INDICATOR ARRAYS WITH RECONFIGURABLE DETECTION WINDOWS,” filed by Charles Dolezalek on Jan. 10, 2022;
U.S. application Ser. No. 16/436,672, titled “Modbus System Having Actual and Virtual Slave Addresses and Slave Sensors,” filed by Robert T. Fayfield, et al., on Jun. 10, 2019, and issued as U.S. Pat. No. 10,805,262 on Oct. 13, 2020;
PCT Application Serial No. PCT/US20/36020, titled “Modbus System Having Actual and Virtual Slave Addresses and Slave Sensors,” filed by Robert T. Fayfield, et al., on Jun. 4, 2020;
Canadian Application Serial No. 3143160, titled “Modbus System Having Actual and Virtual Slave Addresses and Slave Sensors,” filed by Robert T. Fayfield, et al., on Dec. 9, 2021, and issued as U.S. Pat. No. 3,143,160 on Jun. 28, 2022;
Chinese Application Serial No. 2020800428484, titled “Modbus System Having Actual and Virtual Slave Addresses and Slave Sensors,” filed by Robert T. Fayfield, et al., on Dec. 10, 2021, and issued as U.S. Patent No. ZL 2020800428484 on Jul. 8, 2022;
Chinese Application Serial No. 2022107091862, titled “Modbus System Having Actual and Virtual Slave Addresses and Slave Sensors,” filed by Robert T. Fayfield, et al., on Jun. 21, 2022;
European Application Serial No. 20747261.4, titled “Modbus System Having Actual and Virtual Slave Addresses and Slave Sensors,” filed by Robert T. Fayfield, et al., on Dec. 10, 2021; and
Mexican Application Serial No. MX/a/2021/015389, titled “Modbus System Having Actual and Virtual Slave Addresses and Slave Sensors,” filed by Robert T. Fayfield, et al., on Dec. 10, 2021.

This application incorporates the entire contents of the foregoing application(s) herein by reference.

### TECHNICAL FIELD

Various embodiments relate generally to sensing and indication.

### BACKGROUND

Various items may be placed in individual containers such as, for example, assembly, shipping, warehousing, and/or order picking. Items may include, by way of example and not limitation, components, repair parts, and/or finished products. Users may select a predetermined number of items from an assortment of different containers.

Light units may be placed on or about various containers to guide a user in selecting items from various containers in a predetermined sequence. Indicator units may, for example, guide a user in a quantity of a given item to select. Sensing units may, for example, detect when a user interacts with a particular container. Controllers may, for example, operate a predetermined sequence of sensing and indication associated with a plurality of containers.

### SUMMARY

Apparatus and associated methods relate to generate a mapping between reconfigurable predetermined detection windows (RPDWs) and sensing elements across adjacent distance sensing arrays. In an illustrative example, two or more adjacently placed distance sensing arrays may each include sensor elements coupled to uniquely and physically addressable memory registers. A master controller coupled to the distance sensing arrays may, for example, receive a signal to set up a virtual address mapping for a RPDW. For example, the RPDW may associate adjacent distance sensing elements across the two distance sensing arrays. The master controller may, for example, identify activated registers during a teaching operation to generate a mapping between the RPDW and the identified range of activated registers. When the RPDW is monitored, only the registers associated with the virtual address may, for example, be activated to be monitored. Various embodiments may advantageously reduce time and resources for monitoring the RPDW.

Various embodiments may achieve one or more advantages. For example, some embodiments may advantageously improve teaching speed. Some embodiments, for example, may advantageously allow a user to flexibly arrange multiple distance sensing arrays across multiple bins without boundary limitations. For example, some embodiments may advantageously save computation power and reduce response time by reducing the number of registers to be checked to confirm an event. Some embodiments may, for example, advantageously improve polling speed and save resources in monitoring the bin. For example, some embodiments may advantageously be configured to flexibly adapt to various rack configurations.

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary distance sensing and visual indication system (DSVIS) employed in an illustrative pick-to-light use-case scenario.

FIG. 2 is a block diagram depicting an exemplary distance sensing and visual indication virtual addressing system.

FIG. 3 is a flowchart illustrating an exemplary virtual address training method.

FIG. 4 is a flowchart illustrating an exemplary virtual address sensor detection method.

FIG. 5 is a block diagram depicting an exemplary linearly controlled distance sensing array system.

FIG. 6A, FIG. 6B, FIG. 6C, and FIG. 6D depict exemplary applications of the DSVIS.

Like reference symbols in the various drawings indicate like elements.

### DETAILED DESCRIPTION OF ILLUSTRATIVE EMBODIMENTS

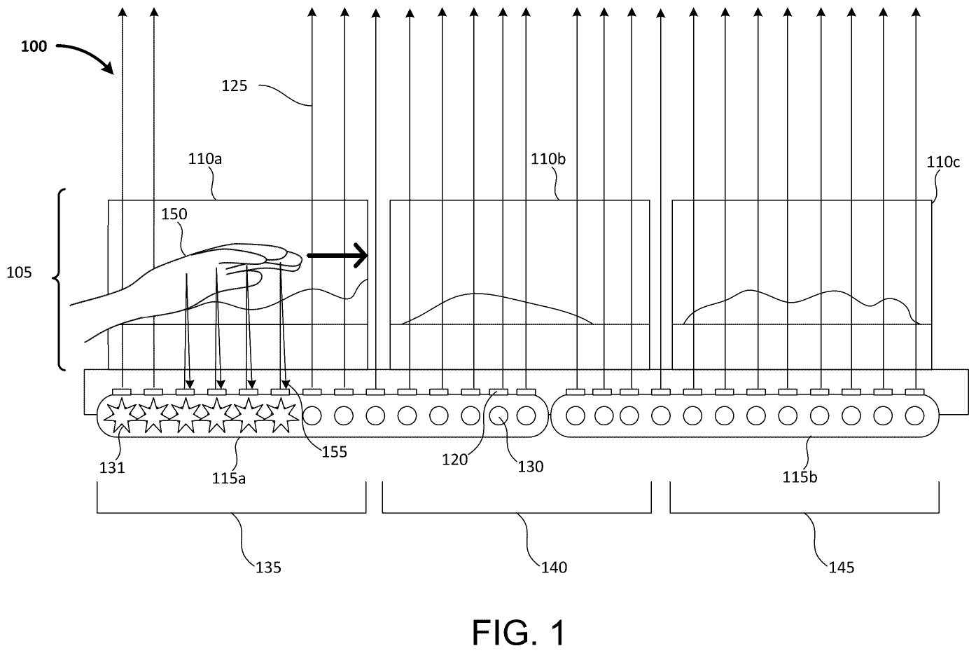

FIG. 1 depicts an exemplary distance sensing and visual indication system (DSVIS) employed in an illustrative pick-to-light (PTL) use-case scenario. In this example, a PTL system 100 includes a shelf 105. The shelf 105 includes three bins 110a, 110b, 110c. Two distance sensing and visual indication units (DSVI units 115a, 115b) are releasably coupled to the shelf 105.

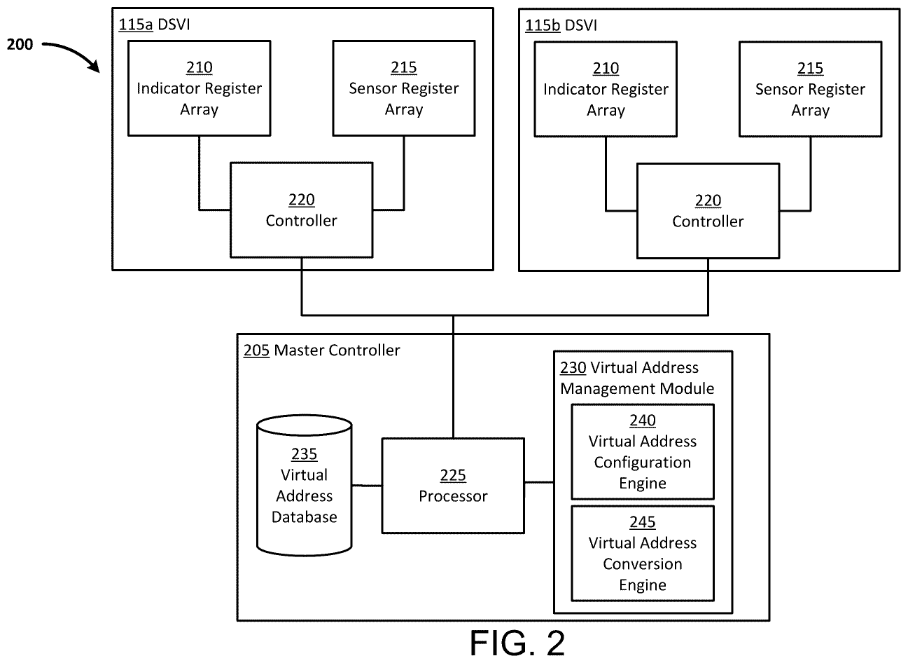

For example, the DSVI unit 115a, 115b may include one or more control circuits. Various embodiments of the control circuits are described in greater details with reference to FIG. 2. Each DSVI unit 115a, 115b is provided with a first array of individually readable distance sensing elements 120 configured to emit electromagnetic signals 125 and detect reflection thereof. For example, sensing data from each of the sensing elements 120 may be independently read by the control circuits connected to the DSVI unit 115a, 115b.

In this example, each DSVI unit 115a, 115b is provided with a second array of individually controllable visual indicators 130, configured to emit visual indicia 131 in response to predetermined events. In some implementations, the control circuits may be configured to define reconfigurable predetermined detection windows (RPDWs 135, 140, 145) by associating adjacent distance sensing elements 120 with a corresponding sensor threshold profile. As shown in FIG. 1, the RPDW 135 is associated with some of the distance sensing elements 120 of the DSVI unit 115a, the RPDW 145 is associated with some of the sensors distance sensing elements 120 of the DSVI unit 115b, and the RPDW 140 is associated with some distance sensing elements 120 of the DSVI unit 115a and some sensors of the DSVI unit 115b. For example, a width of each of the RPDWs 135, 140, 145 may be independently adjusted by the control circuit of the DSVI 115a, 115b.

In some implementations, the PTL system 100 may advantageously detect penetration of one of the RPDW (e.g., the RPDW 135) by an object such as a hand 150. By way of example and not limitation, the DSVI units 115a-b may be configured onto the shelf 105 as a pick-to-light (or put-to-light) system. As depicted, the hand 150 reaches into one of the bins 110a to access bin contents. As the hand 150 enters the bin 110a, it penetrates the corresponding RPDW 135. The hand 150 penetrating the RPDW 135 causes the electromagnetic signals 125 emitted by distance sensing elements 120 to be at least partially reflected. Resulting reflected electromagnetic signals 155 are received by the distance sensing elements 120. The PTL system 100 thereby detects penetration of the corresponding RPDW 135.

In some implementations, each of the DSVI units 115a, 115b may include a high concentration of distance sensing elements 120. For example, the DSVI units 115a, 115b may include 20 sensors per meter. Each of the distance sensing elements 120 within the DSVI units 115a, 115b, may be associated with a physical address, for example. When any of the reflected electromagnetic signals 155 is received by the distance sensing element 120, for example, the corresponding DSVI unit 115a, 115b may generate a signal to a master controller (e.g., a master controller as described in FIG. 2). In some implementations, each of the RPDW 135, 140, 145 may be assigned a virtual address by the master controller. The master controller may use the virtual addresses, for example, to identify detections in the corresponding RPDW 135, 140, 145. For example, when the hand 150 penetrates the RPDW 140, the master controller may generate a signal identifying the penetrations in the bin 110b independent of whether the reflected electromagnetic signals 155 is detected by the DSVI unit 115a or the DSVI unit 115b.

In some examples, the PTL system 100 may include a teaching process to teach the master controller to assign the distance sensing element 120 into the RPDW 135, 140, 145. In some implementations, in the teaching process, the PTL system 100 may monitor only a selected subset of the distance sensing elements 120 to advantageously improve teaching speed. For example, the PTL system 100 may monitor the distance sensing elements 120 at the end of the sensor array of the DSVI units 115a, 115b in the teaching process. For example, the PTL system 100 may monitor only every Nth (e.g., 1, 2, 3, 4, 5, 10) distance sensing elements 120 of the DSVI units 115a, 115b in the teaching process.

In some implementations, the PTL system 100 may be configured to monitor mispick at the shelf 105. As an illustrative example, the PTL system 100 may light up the individually controllable visual indicators 130 within the RPDWs 140 and 145 to identify a user to pick up content from the bins 110b and 110c. For example, the PTL system 100 may independently control on/off of each the individually controllable visual indicators 130 within a RPDW by virtual addresses corresponding to the RPDWs 140, 145. In some examples, the sensor array within the RPDWs 140, 145 may be monitored simultaneously using the virtual address assigned to the RPDWs 140, 145.

FIG. 2 is a block diagram depicting an exemplary distance sensing and visual indication virtual addressing system (DSVIVA system 200). The DSVIVA system 200 includes DSVI units 115a, 115b and a master controller 205. In some implementations, the master controller 205 may be connected to more than two DSVI units (e.g., 4, 6, 8, 10, 20). Each of the DSVI units 115a, 115b includes an indicator register array (IRA 210) and a sensor register array (SRA 215). For example, the IRA 210 may include an array of registers. For example, each register may be individually (e.g., independently) addressable (with a physical address). In some implementations, the controller 220 may control an indicator corresponding to a register in the IRA 210 by controlling the value at the register (corresponding to one of the individually controllable visual indicators 130). In some implementations, the DSVI unit 115a, 115b may include a display unit (e.g., an LCD monitor, an LED monitor). For example, the display unit may be configured to display text. For example, the display unit may display a number of units to be picked out from a particular bin (e.g., the bins 110a/110b/110c) indicated by the visual indicia 131.

For example, the SRA 215 may include an array of registers. For example, the SRA 215 may correspond to the distance sensing elements 120 of the DSVI 115a, 115b. For example, each register may be individually addressable (with a physical address). In some implementations, the controller 220 may poll (individually) a detection signal from each sensor in the SRA 215 by polling a corresponding register of the sensors. For example, the SRA 215 may be connected to the controller 220 by a sensor device via a Modbus protocol. The sensor device, for example, may individually poll a detection status of a corresponding sensor using the Modbus protocol.

As shown, the master controller 205 includes a processor 225. For example, the processor 225 may include a microprocessor. The processor 225 may, for example, execute instructions to configure and convert a physical address of a sensor (registers in the SRA 215) into a virtual address. In this example, the master controller 205 includes a virtual address management module (VAMM 230) and a virtual address database 235. For example, the VAMM 230 may be embedded in a data store. For example, the VAMM 230 may include a program of instructions configured to control the DSVI units 115a, 115b. In this example, the VAMM 230 includes a virtual address configuration engine 240 and a virtual address conversion engine 245. For example, the processor 225 may use the VAMM 230 to configure the physical addresses in the SRA 215 into virtual addresses based on actual locations of the bins 110a-c.

In some implementations, the VAMM 230 may include a teaching process to set up the virtual addresses according to the RPDWs corresponding to the bins. In some examples, the VAMM 230 may assign a virtual address to each RPDW. After the teaching process, for example, the virtual address and the physical address of the sensor registers may be stored in the virtual address database 235. The virtual address conversion engine 245 may, for example, convert a signal from a physical register into a virtual address, and from a virtual address to a physical register.

In some implementations, when an RPDW spans more than one DSVI unit, for example, the VAMM 230 may associate corresponding registers in the SRA 215 in both DSVI units 115a, 115b to the same virtual address. Accordingly, for example, the DSVIVA system 200 may advantageously allow a user to flexibly arrange multiple DSVI units 115a, 115b, across multiple bins without boundary limitations (e.g., a DSVI must correspond to one bin, a bin cannot span across two DSVIs.).

As an illustrative example, the DSVI unit 115a may include 10 sensors (A1-A10), and the DSVI unit 115b may include 10 sensors (B1-B10). For example, the master controller 205 may assign a virtual address V1 to A1:A7, V2 to A9-A10 and B1-B3, and V3 to B5-B10. For example, the master controller 205 may monitor the DSVI units 115a, 115b by polling for a change in the virtual addresses V1-V3. For example, the controller 220 of DSVI unit 115a may generate a signal in response to the polling that A10 is tripped. In some examples, the master controller 205 may, based on the virtual address V2, check the register A9 and B1-B3 whether they are tripped also. In various implementations, the virtual addresses may advantageously save computation power and reduce response time by reducing the number of registers to be checked to confirm an event.

In some implementations, the master controller 205 may also include logic to independently control illumination of the individually controllable visual indicators 130 at different RPDWs using the virtual address in the virtual address database 235. For example, in the PTL system 100 as described in FIG. 1, the master controller 205 may control to illuminate the individually controllable visual indicators 130 in the RPDW 135 to be flashing in red. At the same time, using the virtual address in the virtual address database 235, the master controller 205 may control the individually controllable visual indicators 130 in the RPDW 140 to be off, for example. For example, the master controller 205 may also at the same time independently control the individually controllable visual indicators 130 in the RPDW 145 to be in solid green using the virtual address in the virtual address database 235.

In various implementations, the DSVI 115a, 115b may independently adjust a sensing distance of the distance sensing elements 120 at each of the RPDWs 135, 140, 145. As an illustrative example without limitation, the master controller 205 may transmit a signal, using the virtual addresses associated with the RPDWs 135, 140, 145, to configured that a sensing distance of the distance sensing elements 120 in the RPDW 135 to be 15 cm, a sensing distance of the distance sensing elements 120 in the RPDW 140 to be 20 cm, and a sensing distance of the distance sensing elements 120 in the RPDW 145 to be 10 cm.

In various implementations, the DSVIVA system 200 may create a single detection window (e.g., a RPDW) by associating together, with a uniquely addressable address (e.g., uniquely addressable address for the SRA 215), at least one individually addressable distance sensor (e.g., the distance sensing elements 120) from each of two or more adjacent detection units (e.g., the DSVI unit 115a and the DSVI unit 115b). For example, in some embodiments, for a uniquely addressable window (e.g., the RPDW) defined by associated sensors selected from adjacent sensing units (e.g., the DSVI unit 115a and the DSVI unit 115b), the master controller 205 may advantageously monitor only physical register addresses of the sensing units (e.g., the distance sensing elements 120) that are associated with the uniquely addressable window.

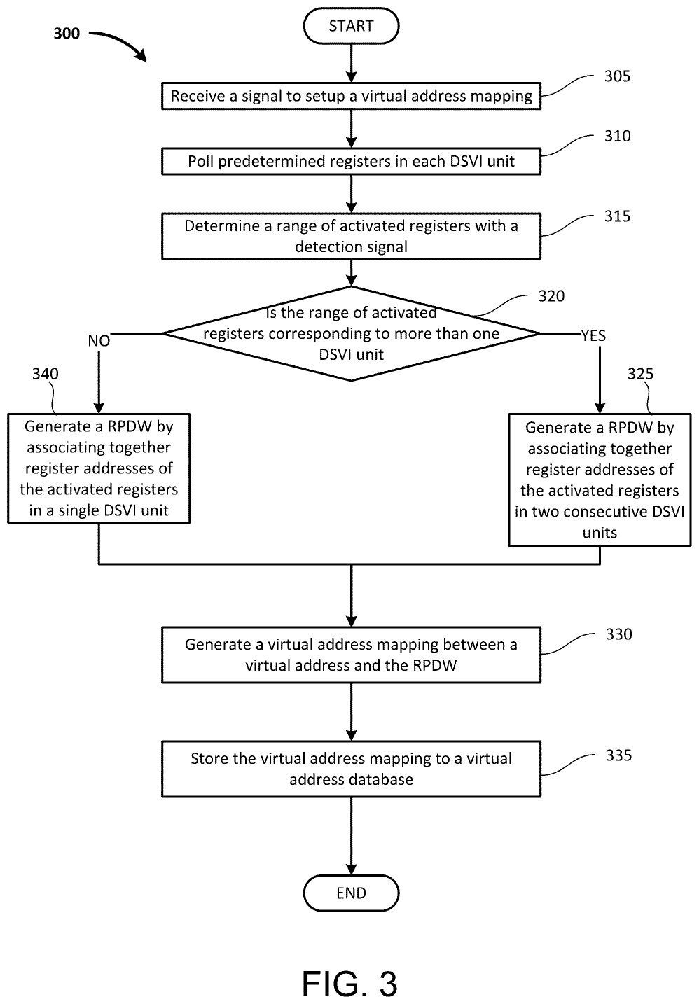

FIG. 3 is a flowchart illustrating an exemplary virtual address training method 300. For example, the method 300 may be performed by the virtual address configuration engine 240 to generate a mapping between physical registers of sensors into virtual addresses corresponding to the RPDWs. The method 300 begins when a signal is received to set up a virtual address for a RPDW in step 305. For example, a user may use a user interface of the master controller 205 to transmit the signal to set up a virtual address for a RPDW (e.g., when configuration of the bins 110a-c are changed). In step 310, predetermined registers are polled in each DSVI unit. For example, a user may place a hand in the bin to teach the DSVIVA system 200 to associate one or more sensor registers to the bin. In some implementations, the user may select the master controller 205 to monitor only some of the DVSI in a system to advantageously improve polling speed in the teaching mode.

Next, in step 315, a range of activated registers are determined with a detection signal. For example, the DSVIVA system 200 may determine, based on a value in the sensor registers, which of the sensors are activated when the user placed the hand in the bin.

In a decision point 320, it is determined whether the range of activated registers correspond to more than one DSVI unit. If it is determined that the range of activated registers correspond to more than one DSVI unit, in step 325, a RPDW is generated by associating together register addresses of the activated registers in two consecutive DSVI units. For example, the virtual address configuration engine 240 may associate the register addresses of the SRA 215 to generate a RPDW.

Next, a virtual address mapping between a virtual address and the RPDW is generated in step 330. For example, the VAMM 230 may generate the virtual address mapping. In step 335, the virtual address mapping is stored in a virtual address database, and the method 300 ends. If it is determined that, in the decision point 320, the range of activated registers do not correspond to more than one DSVI unit, a RPDW is generated by associating together register addresses of the activated registers in a single DSVI unit in step 340, and the step 330 is repeated.

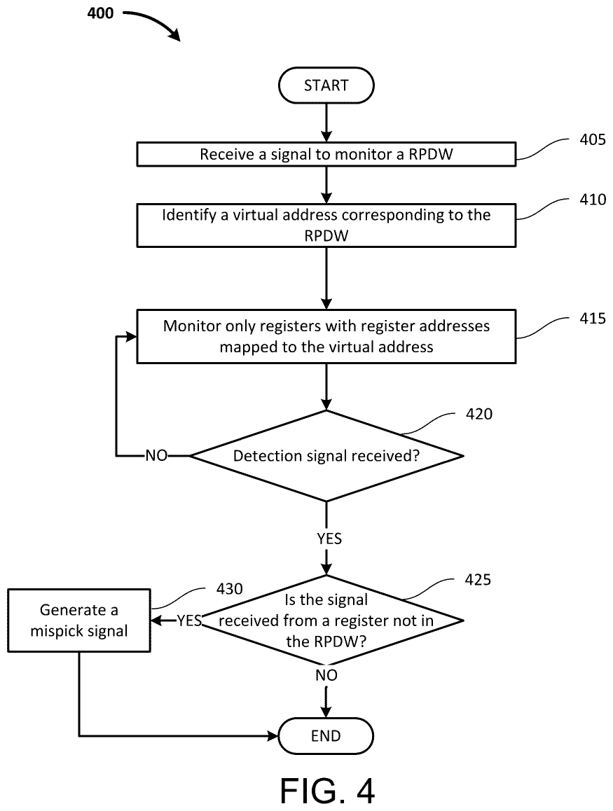

FIG. 4 is a flowchart illustrating an exemplary virtual address sensor detection method 400. For example, the method 400 may be performed by the VAMM 230 using the virtual address conversion engine 245. The method 400 begins when, in step 405, a signal is received to monitor a RPDW (e.g., a bin on a shelf). Next, in step 410, a virtual address is identified corresponding to the RPDW. For example, the virtual address conversion engine 245 may retrieve, from the virtual address database 235, a virtual address mapping to convert the RPDW into a virtual address. In step 415, only registers with register addresses mapped to the virtual address are monitored. For example, accordingly, the DSVIVA system 200 may advantageously improve polling speed and save resources in monitoring only the registers within the RPDW.

In a decision point 420, it is determined whether a detection signal is received. If the detection signal is not received, the step 415 is repeated. If the detection signal is received, in a decision point 425, it is determined whether the signal is received from a register not in the RPDW. For example, the processor 225 may use the virtual address conversion engine 245 to determine whether the register signal is within the RPDW. If the signal is received from a register within the RPDW, the method 400 ends. If, in the decision point 425, the signal is not received from a register within the RPDW, a mispick signal is generated in step 430, and the method 400 ends.

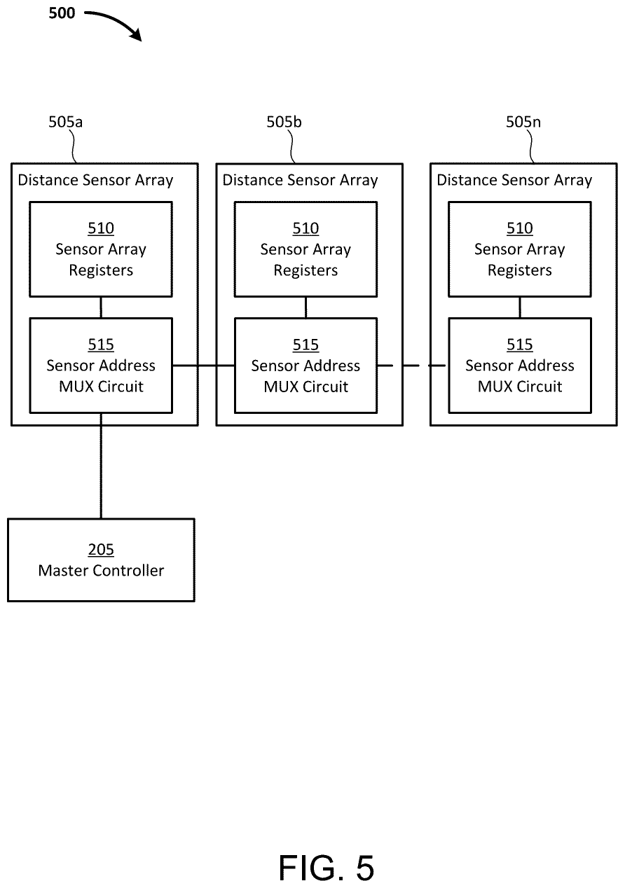

FIG. 5 is a block diagram depicting an exemplary linearly controlled distance sensing array (LCDSA) system 500. In some implementations, the LCDSA system 500 may include a master and slave linear array to reduce costs and a required number of microprocessor chips in the system 500.

In this example, the LCDSA system 500 includes a master controller 205 serially connected to a number of distance sensor arrays 505a, 505b, . . . , 505n. The distance sensor arrays 505a, 505b, . . . , 505n include sensor array registers 510 and a sensor address multiplexing (MUX) circuit 515. For example, the distance sensor arrays 505a, 505b, . . . , 505n may be configured to detect objects within a bin placed above the distance sensor arrays 505a, 505b, . . . , 505n. The sensor array registers 510 may, for example, include an array of registers, each corresponding to a sensor unit in the distance sensor array. The sensor array registers 510 couples to the sensor address MUX circuit 515. In some implementations, the sensor address MUX circuit 515 may generate unique physical addresses for each of the sensor array registers 510 within the LCDSA system 500 based on a multiplexed addressing scheme. For example, the sensor address MUX circuit 515 of the distance sensor array 505a may add a leading distance sensing array identification (e.g., “A-”) to each of the physical address of the sensor register (e.g., suppose a physical address is 1234, the sensor address MUX circuit 515 may convert the address into A1234 to be used by the master controller 205). In this example, the sensor address MUX circuit 515 may allow signals from other distance sensor arrays in the system 500 to pass through.

In some implementations, the master controller 205 may be trained to generate a mapping between physical addresses of sensor registers in the distance sensor arrays 505a, 505b, . . . , 505n and virtual addresses based on placement of bins. For example, the master controller 205 may generate a mapping between the physical address of the sensor registers and virtual addresses corresponding to bin placement as described with reference to FIGS. 2-3. For example, the master controller 205 may advantageously monitor a portion of the sensor registers across one or more distance sensor arrays 505a-n to advantageously improve polling speed and reduce resource consumption.

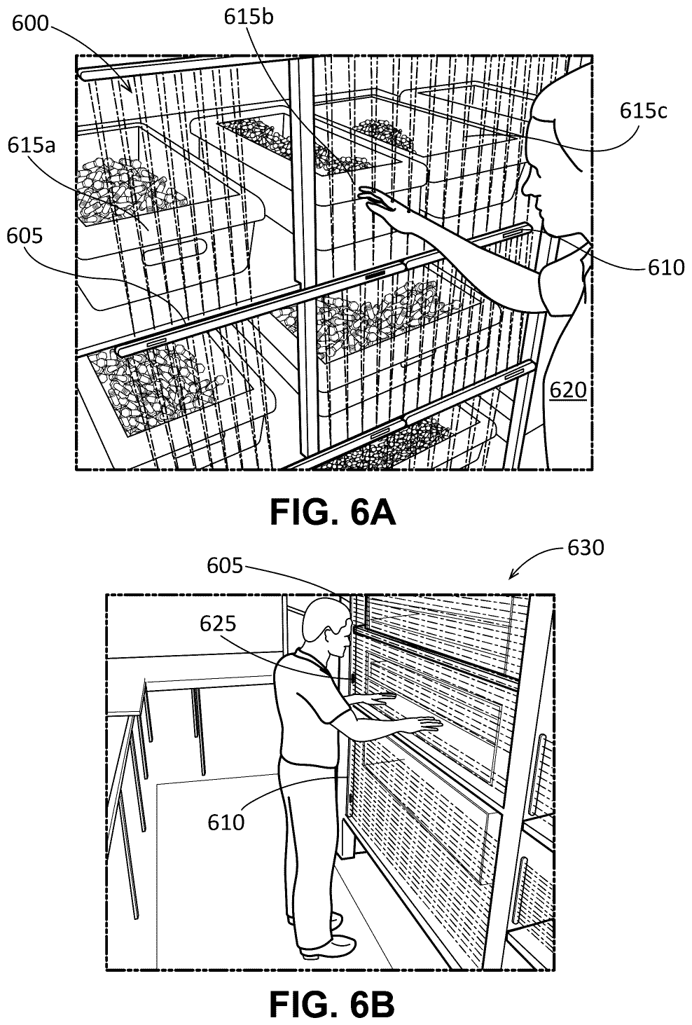

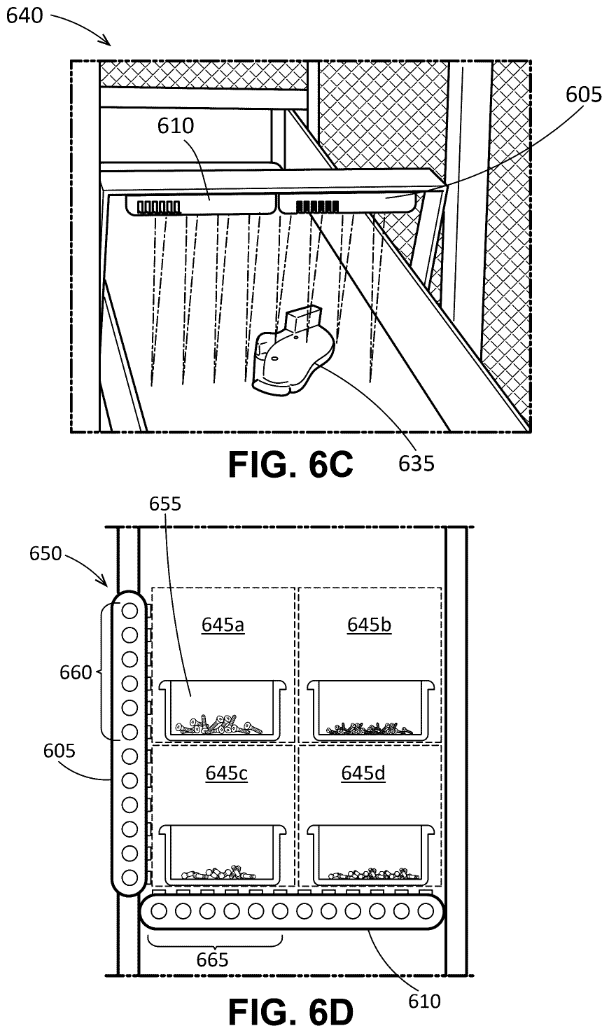

FIG. 6A, FIG. 6B, FIG. 6C, and FIG. 6D depict exemplary applications of the DSVIS. As shown in FIG. 6A, a PTL system 600 includes a DSVI 605. For example, a DSVI 605 and a DSVI 610 may be associated with three bins 615a-c. In this example, a user 620 is accessing a bin 615b. For example, visual indicators of a corresponding RPDW associated with the bin 615b is activated to indicate that the bin 615b is being accessed.

As shown in FIG. 6B, the DSVI 605 and the DSVI 610 are deployed in a vertical orientation. For example, the master controller 205 may control a visual indicator 625 of the DSVI 605 to be activated to indicate a location of a next item to be picked up from a rack 630. Accordingly, the DSVI 605, 610 may be advantageously configured to flexibly adapt to various configurations of the rack 630.

As shown in FIG. 6C, the DSVI 605 and the DSVI 610 are installed in a conveyor belt system. In this example, the DSVI 605 and the DSVI 610 are configured to detect an object 635 passing through a conveyor belt system 640. For example, by independently reconfiguring the RPDWs of the DSVIs 605 and 610, a user may advantageously flexibly fit any width of the conveyor belt.

As shown in FIG. 6D, the DSVI 605 and the DSVI 610 are arranged in two dimensions. For example, the DSVIVA system 200 may configure four two-dimensional RPDWs 645a-d in a PTL system 650. For example, the master controller 205 may indicate items to be retrieved from a bin 655 by lighting up visual indicators 660 and visual indicators 665.

Although various embodiments have been described with reference to the figures, other embodiments are possible. In some embodiments, the master controller 205 may configure some RPDWs to be deactivated. For example, the master controller 205 may deactivate some unused RPDW (e.g., not RPDWs that are not corresponding to any bins in the PTL system 100) to advantageously conserve computation power. For example, the master controller 205 may be configured to designate a deactivated RPDW between two activated RPDWs to advantageously avoid false detection (e.g., across two bins).

In an exemplary illustrative aspect, at least one processor may perform a computer-implemented method to automatically generate a mapping between a reconfigurable predetermined detection window among a plurality of distance sensing units during a teaching mode of operation. For example, the method may include receiving a signal to set up a virtual address mapping for a reconfigurable predetermined detection window. For example, the reconfigurable predetermined detection window may include associating adjacent distance sensing elements of a plurality of distance sensing units. For example, each of the plurality of distance sensing units may include a plurality of sensor elements and a register space that may include a plurality of physically and uniquely addressable registers corresponding to each of the plurality of sensor elements. The method may include identifying a predetermined set of registers in the register space of each of at least one of the distance sensing units. The method may include polling each of the registers in the identified range of registers to determine which of the registers may be activated to indicate an object may be within that sensor element's detection field. The method may, for example, include determining a range of registers corresponding to the polled sensing elements that may be activated. For example, the sensing elements corresponding to the range of activated registers may span across at least two distance sensing units. For example, the method may include generating a mapping between a virtual address associated with the reconfigurable predetermined detection window and the determined range of activated registers. The method may include storing the generated mapping within a storage device.

For example, upon receiving an instruction to monitor the reconfigurable predetermined detection window, only the registers associated with the virtual address may be activated to be monitored such that, for example, computational resources for monitoring the reconfigurable predetermined detection window may be reduced.

For example, each of the plurality of physically and uniquely addressable registers may be uniquely addressable by a master controller. For example, the master controller and the distance sensing units may be serially coupled. For example, each of the distance sensing units may include a multiplexing circuit configured to allow upstream signals to pass through. For example, the method may include transferring and receiving signals addressed to the corresponding distance sensing unit based on a multiplexed addressing scheme so that processor units and connectors required to couple the master controller to the plurality of distance sensing units may be reduced.

For example, the predetermined range of registers may include a user-selected range of adjacent distance sensing units that, in the teaching operation, only a portion of the distance sensing units may be monitored.

The method may include receiving a signal to monitor more than one reconfigurable predetermined detection window simultaneously. The method may include, upon determining that a detection signal is received at one of the reconfigurable predetermined detection windows, identifying the virtual address of the corresponding reconfigurable predetermined detection windows. For example, the method may include deactivating monitoring of the range of registers associated with the identified virtual address.

For example, registers associated with the distance sensor may include values of sensor status, signal level value, and distance value. For example, monitoring the registers may include polling on a Modbus. For example, monitoring the registers may include polling on an IOLink. For example, the method may include, upon receiving a detection signal in a deactivated range of registers, transmitting a signal to indicate a mispick within the corresponding reconfigurable predetermined detection window.

In another illustrative aspect, a system may include a plurality of distance sensing units, each may include a plurality of sensor elements, and a register space that may include a plurality of physically and uniquely addressable registers corresponding to each of the plurality of sensor elements. For example, the system may include a data store including a program of instructions configured to control the plurality of distance sensing units. For example, the system may include a processor operably coupled to the data store such that, when the processor executes the program of instructions, the processor causes operations to be performed during a teaching mode of operation to generate a mapping between a reconfigurable predetermined detection window among the distance sensing units and the sensor elements. For example, the operations may include receiving a signal to set up a virtual address mapping for a reconfigurable predetermined detection window. The operations may include identifying a predetermined set of registers in the register space of each of at least one of the distance sensing units. For example, the operations may include polling each of the registers in the identified range of registers to determine which of the registers may be activated to indicate an object may be within that sensor element's detection field.

The operations may include determining a range of registers corresponding to the polled sensing elements that may be activated and adjacent to at least one other activated sensing element. The operations may include generating a mapping between a virtual address associated with the reconfigurable predetermined detection window and the determined range of activated registers. For example, the operations may include storing the generated mapping in a storage device. For example, upon receiving an instruction to monitor the reconfigurable predetermined detection window, the determined range of activated registers associated with the virtual address may be independently activated to be monitored. For example, time and computational resources for monitoring the reconfigurable predetermined detection window may be reduced.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAS, ASICs), or some combination thereof. In some embodiments, the module(s) may involve execution of preprogrammed instructions, software executed by a processor, or some combination thereof. For example, various modules may involve both hardware and software.

In an illustrative aspect, a system may include at least two adjacent distance sensing units. For example, each may include a plurality of sensor elements. For example, each of the plurality of sensor elements may be activated upon detecting an object within a predetermined activation distance from a corresponding sensing element at a sensing direction. For example, a sensor signal may be generated upon activation of the corresponding sensing element.

For example, the system may include a plurality of independently addressable registers. For example, each of the plurality of independently addressable registers may be configured to store the sensor signal may correspond to at least one of the plurality of sensor elements. For example, the system may include a data store may include a program of instructions configured to control the at least two adjacent distance sensing units. For example, the system may include a processor operably coupled to the data store and the plurality of independently addressable registers such that, when the processor executes the program of instructions, the processor may cause operations to be performed to generate a mapping between one or more user-selected reconfigurable detection windows and the plurality of independently addressable registers of the at least two adjacent distance sensing units.

For example, the operations may include receive a signal to begin a teaching mode of operation at the at least two adjacent distance sensing units to generate a virtual address mapping. For example, the operations may include poll a predetermined set of the plurality of independently addressable registers to determine a range of activated sensor elements among the plurality of sensor elements of the at least two adjacent distance sensing units. For example, the operations may include generate a user-selected reconfigurable detection window by associating together a range of activated register addresses corresponding to the range of activated sensor elements. For example, the operations may include generate the virtual address mapping between a virtual address and the user-selected reconfigurable detection window.

For example, if the range of activated sensor elements may be distributed across the at least two adjacent distance sensing units, the user-selected reconfigurable detection window may be configured to distribute across the at least two adjacent distance sensing units, such that, based on the virtual address mapping, the range of activated sensor elements within the user-selected reconfigurable detection window may be addressed independent of the at least two adjacent distance sensing units.

For example, the operations may include receive a signal to begin a monitor mode of operation for monitoring a reconfigurable detection window across the at least two adjacent distance sensing units. For example, the operations may include retrieve the virtual address mapping from a data store. For example, the operations may include identify a virtual address uniquely corresponding to the reconfigurable detection window based on the virtual address mapping. For example, the virtual address may be mapped to a plurality of register addresses corresponding to the user-selected reconfigurable detection window. For example, the operations may include monitor only the plurality of register addresses mapped to the virtual address such that computational resources for monitoring the reconfigurable detection window may be reduced.

For example, the system may include a master controller configured to uniquely address each of the plurality of independently addressable registers. For example, each of the at least two adjacent distance sensing units may include a multiplexing circuit. For example, the multiplexing circuit may include a multiplexed addressing scheme. For example, the multiplexed addressing scheme may include a mapping may correspond to unique physical addresses of the plurality of independently addressable registers of a corresponding distance sensing unit.

For example, when the master controller and the at least two adjacent distance sensing units may be coupled in series, the multiplexing circuit may be configured to allow upstream signals to pass through, and transfer and receive signals addressed to one of the at least two adjacent distance sensing units based on the multiplexed addressing scheme. For example, processor units and connectors required to couple the master controller to the at least two adjacent distance sensing units may be reduced.

For example, each of the independently and uniquely addressable registers may include a sensor status value, a signal level value, and a distance value. For example, the sensor status value may correspond to an activation of a sensor element corresponding to an independently and uniquely addressable register.

For example, each of the at least two adjacent distance sensing units may include a control circuit. For example, the control circuit may be configured to independently adjust the predetermined activation distance by comparing the distance value to an adjustable activation threshold.

In an illustrative aspect, a computer-implemented method performed by at least one processor to automatically generate a mapping between at least one reconfigurable predetermined detection window and a plurality of distance sensing units, the method may include receive a signal to set up a virtual address mapping for a reconfigurable predetermined detection window within at least two distance sensing units.

For example, each of the at least two distance sensing units may include a plurality of sensor elements. For example, each of the plurality of sensor elements may be activated upon detecting an object within a predetermined activation distance from a corresponding sensing element at a sensing direction. For example, a sensor signal may be generated upon activation of the corresponding sensing element. For example, a register array may include independently and uniquely addressable registers. For example, each of the independently and uniquely addressable registers may correspond to at least one of the plurality of sensor elements.

For example, the method may include poll a predetermined set of the independently and uniquely addressable registers to determine a range of activated sensor elements among the plurality of sensor elements of the at least two distance sensing units. For example, the method may include generate the reconfigurable predetermined detection window by associating together a range of independently and uniquely addressable registers corresponding to the range of activated sensor elements. For example, the reconfigurable predetermined detection window may span across the at least two distance sensing units. For example, the method may include generate the virtual address mapping between a virtual address and the reconfigurable predetermined detection window. For example, the method may include store the virtual address mapping within a storage device.

For example, the at least two distance sensing units are positioned adjacent to each other. For example, the method may include, upon receiving an instruction to monitor a reconfigurable detection window, retrieve the virtual address mapping from the storage device. For example, the method may include identify a virtual address uniquely corresponding to the reconfigurable predetermined detection window based on the virtual address mapping associated with a range of independently and uniquely addressable registers. For example, the method may include monitor only the range of independently and uniquely addressable registers such that computational resources for monitoring the reconfigurable detection window may be reduced.

For example, the method may include, upon receiving a detection signal from a register not within the reconfigurable detection window, transmit a signal to indicate a mispick. For example, the predetermined set of the independently and uniquely addressable registers may include a user-selected range of adjacent distance sensing units such that only a portion of the independently and uniquely addressable registers may be polled.

For example, each of the independently and uniquely addressable registers may include a sensor status value, a signal level value, and a distance value. For example, the sensor status value may correspond to an activation of a sensor element corresponding to an independently and uniquely addressable register.

For example, the method may include poll the predetermined set of the independently and uniquely addressable registers may include polling on a Modbus. For example, the method may include poll the predetermined set of the independently and uniquely addressable registers may include polling on an IOLink.

In an illustrative aspect, a computer program product may include a program of instructions tangibly embodied on a non-transitory computer readable medium. For example, when the instructions are executed on a processor, the processor may cause virtual address mapping operations to be performed to automatically generate a mapping between a reconfigurable predetermined detection window among a plurality of distance sensing units. For example, the operations may include receive a signal to set up a virtual address mapping for a reconfigurable predetermined detection window within at least two distance sensing units.

For example, each of the at least two distance sensing units may include a plurality of sensor elements. For example, each of the plurality of sensor elements may be activated upon detecting an object within a predetermined activation distance from a corresponding sensing element at a sensing direction. For example, a sensor signal may be generated upon activation of the corresponding sensing element. For example, a register array may include independently and uniquely addressable registers. For example, each of the independently and uniquely addressable registers may correspond to at least one of the plurality of sensor elements.

For example, the operations may include poll a predetermined set of the independently and uniquely addressable registers to determine a range of activated sensor elements among the plurality of sensor elements of the at least two distance sensing units. For example, the operations may include generate the reconfigurable predetermined detection window by associating together a range of independently and uniquely addressable registers corresponding to the range of activated sensor elements. For example, the reconfigurable predetermined detection window may span across the at least two distance sensing units.

For example, the operations may include generate a virtual address mapping between a virtual address and the reconfigurable predetermined detection window. For example, the operations may include store the virtual address mapping within a storage device.

For example, the at least two distance sensing units may be positioned adjacent to each other. For example, the operations may include, upon receiving an instruction to monitor a reconfigurable detection window, retrieve the virtual address mapping from the storage device. For example, the operations may include identify a virtual address uniquely corresponding to the reconfigurable predetermined detection window based on the virtual address mapping. For example, the operations may include monitor only the range of independently and uniquely addressable registers such that computational resources for monitoring the reconfigurable detection window may be reduced.

For example, the operations may include, upon receiving a detection signal from a register not within the reconfigurable detection window, transmit a signal to indicate a mispick. For example, the predetermined set of the independently and uniquely addressable registers may include a user-selected range of adjacent distance sensing units such that only a portion of the independently and uniquely addressable registers may be polled. For example, polling the predetermined set of the independently and uniquely addressable registers may include polling on a Modbus.

In some illustrative examples, the system of any of [0060-68] may be combined with any of the computer-implemented method of [0069-75]. In some illustrative examples, the system of any of [0060-68] may be combined with any of the computer program product of [0076-81].

In some illustrative examples, the computer-implemented method any of [0069-75] may be combined with any of the system of [0060-68]. In some illustrative examples, the computer-implemented method any of [0069-75] may be combined with any of the computer program product of [0076-81].

In some illustrative examples, the computer program product of any of [0076-81] may be combined with any of the system of [0060-68]. In some illustrative examples, the computer program product of any of [0076-81] may be combined with any of the computer-implemented method of [0069-75].

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A system comprising:
at least two adjacent distance sensing units, both aligned adjacent to each other and extending along a single axis, each comprises:
a plurality of sensor elements disposed adjacent to each other along the single axis, wherein each of the plurality of sensor elements is activated upon detecting an object within a predetermined activation distance from a corresponding sensing element at a sensing direction, wherein a sensor signal is generated upon activation of the corresponding sensing element,
a plurality of independently addressable registers, wherein each of the plurality of independently addressable registers is configured to store the sensor signal corresponds to at least one of the plurality of sensor elements; and,
a controller operably coupled to the plurality of independently addressable registers and configured to individually poll the sensor signal from the plurality of independently addressable registers; and,
a data store comprising a program of instructions configured to control the at least two adjacent distance sensing units; and,
a processor operably coupled to the data store and the controller such that, when the processor executes the program of instructions, the processor causes operations to be performed generate a mapping between one or more user-selected reconfigurable detection windows and the plurality of independently addressable registers of the at least two adjacent distance sensing units, the operations comprising:
receive a signal to begin a teaching mode of operation at the at least two adjacent distance sensing units to generate a virtual address mapping;
poll, through the controller, a predetermined set of the plurality of independently addressable registers to determine a range of activated sensor elements among the plurality of sensor elements of the at least two adjacent distance sensing units;
generate a user-selected reconfigurable detection window by associating together a range of activated register addresses corresponding to the range of activated sensor elements; and,
generate the virtual address mapping between a virtual address and the user-selected reconfigurable detection window, wherein, when the range of activated sensor elements are distributed across the at least two adjacent distance sensing units, the user-selected reconfigurable detection window is configured to distribute across the at least two adjacent distance sensing units, such that, based on the virtual address mapping, the range of activated sensor elements within the user-selected reconfigurable detection window are activated to be monitored by the processor independent of the physical boundary of the at least two adjacent distance sensing units.

2. The system of claim 1, wherein the operations comprise:
receive a signal to begin a monitor mode of operation for monitoring a reconfigurable detection window across the at least two adjacent distance sensing units;
retrieve the virtual address mapping from a data store;
identify a virtual address uniquely corresponding to the reconfigurable detection window based on the virtual address mapping, wherein the virtual address is mapped to a plurality of register addresses corresponding to the user-selected reconfigurable detection window; and,
monitor only the plurality of register addresses mapped to the virtual address such that computational resources for monitoring the reconfigurable detection window are reduced.

3. The system of claim 1, comprises a master controller configured to uniquely address each of the plurality of independently addressable registers.

4. The system of claim 3, wherein each of the at least two adjacent distance sensing units comprises a multiplexing circuit, wherein the multiplexing circuit comprises a multiplexed addressing scheme, and the multiplexed addressing scheme comprises a mapping corresponds to unique physical addresses of the plurality of independently addressable registers of a corresponding distance sensing unit, wherein, when the master controller and the at least two adjacent distance sensing units are coupled in series, the multiplexing circuit configured to:
allow upstream signals to pass through, and,
transfer and receive signals addressed to one of the at least two adjacent distance sensing units based on the multiplexed addressing scheme, such that processor units and connectors required to couple the master controller to the at least two adjacent distance sensing units are reduced.

5. The system of claim 1, wherein each of the plurality of independently addressable registers comprises a sensor status value, a signal level value, and a distance value, wherein the sensor status value corresponds to an activation of a sensor element corresponding to an independently and uniquely addressable register.

6. The system of claim 5, wherein each of the at least two adjacent distance sensing units comprises a control circuit, wherein the control circuit is configured to independently adjust the predetermined activation distance by comparing the distance value to an adjustable activation threshold.

7. The system of claim 2, wherein monitor only the plurality of register addresses mapped to the virtual address comprises deactivate an unused reconfigurable detection window adjacent to the reconfigurable detection window.

8. The system of claim 7, wherein the processor is configured to deactivate the unused reconfigurable detection window when it is between two activated reconfigurable detection windows such that false detection is reduced.

9. A computer-implemented method performed by at least one processor to automatically generate a mapping between at least one reconfigurable predetermined detection window and a plurality of distance sensing units, the method comprising:
receive a signal to set up a virtual address mapping for a reconfigurable predetermined detection window within at least two distance sensing units, wherein the at least two distance sensing units extend along a single axis, each of the at least two distance sensing units aligns adjacent to each other and comprises:
a plurality of sensor elements disposed adjacent to each other along the single axis, wherein each of the plurality of sensor elements is activated upon detecting an object within a predetermined activation distance from a corresponding sensing element at a sensing direction, wherein a sensor signal is generated upon activation of the corresponding sensing element,
a register array comprising independently and uniquely addressable registers, wherein each of the independently and uniquely addressable registers corresponds to at least one of the plurality of sensor elements; and,
a controller operably coupled to the register array and configured to individually poll the sensor signal from the independently and uniquely addressable registers of the register array; and,
poll, through the controller, a predetermined set of the independently and uniquely addressable registers to determine a range of activated sensor elements among the plurality of sensor elements of the at least two distance sensing units;
generate the reconfigurable predetermined detection window by associating together a range of independently and uniquely addressable registers corresponding to the range of activated sensor elements, wherein the reconfigurable predetermined detection window spans across the at least two distance sensing units;
generate the virtual address mapping between a virtual address and the reconfigurable predetermined detection window; and,
store the virtual address mapping within a storage device, such that each of the independently and uniquely addressable registers are addressable by a corresponding virtual address of the virtual address mapping without boundary limitations of the at least two distance sensing units when the reconfigurable predetermined detection window spans across the at least two distance sensing units.

10. The computer-implemented method of claim 9, wherein the at least two distance sensing units are positioned adjacent to each other.

11. The computer-implemented method of claim 9, comprises:
upon receiving an instruction to monitor a reconfigurable detection window, retrieve the virtual address mapping from the storage device;
identify a virtual address uniquely corresponding to the reconfigurable predetermined detection window based on the virtual address mapping associated with a range of independently and uniquely addressable registers; and,
monitor only the range of independently and uniquely addressable registers such that computational resources for monitoring the reconfigurable detection window are reduced.

12. The computer-implemented method of claim 10, comprises,
upon receiving a detection signal from a register not within the reconfigurable detection window, transmit a signal to indicate a mispick.

13. The computer-implemented method of claim 9, wherein the predetermined set of the independently and uniquely addressable registers comprise a user-selected range of adjacent distance sensing units such that only a portion of the independently and uniquely addressable registers are polled.

14. The computer-implemented method of claim 9, wherein each of the independently and uniquely addressable registers comprises a sensor status value, a signal level value, and a distance value, wherein the sensor status value corresponds to an activation of a sensor element corresponding to an independently and uniquely addressable register.

15. The computer-implemented method of claim 9, wherein poll the predetermined set of the independently and uniquely addressable registers comprises polling on a Modbus.

16. The computer-implemented method of claim 9, wherein poll the predetermined set of the independently and uniquely addressable registers comprises polling on an IOLink.

17. A computer program product comprising a program of instructions tangibly embodied on a non-transitory computer readable medium wherein, when the instructions are executed on a processor, the processor causes virtual address mapping operations to be performed to automatically generate a mapping between a reconfigurable predetermined detection window among a plurality of distance sensing units, the operations comprising:
receive a signal to set up a virtual address mapping for a reconfigurable predetermined detection window within at least two distance sensing units (305), wherein the at least two distance sensing units extend along a single axis, each of the at least two distance sensing units aligns adjacent to each other and comprises:
a plurality of sensor elements disposed adjacent to each other along the single axis, wherein each of the plurality of sensor elements is activated upon detecting an object within a predetermined activation distance from a corresponding sensing element at a sensing direction, wherein a sensor signal is generated upon activation of the corresponding sensing element,
a register array comprising independently and uniquely addressable registers, wherein each of the independently and uniquely addressable registers corresponds to at least one of the plurality of sensor elements; and,
a controller operably coupled to the register array and configured to individually poll the sensor signal from the independently and uniquely addressable registers of the register array; and,
poll, through the controller, a predetermined set of the independently and uniquely addressable registers to determine a range of activated sensor elements among the plurality of sensor elements of the at least two distance sensing units;
generate the reconfigurable predetermined detection window by associating together a range of independently and uniquely addressable registers corresponding to the range of activated sensor elements, wherein the reconfigurable predetermined detection window spans across the at least two distance sensing units;
generate a virtual address mapping between a virtual address and the reconfigurable predetermined detection window; and,
store the virtual address mapping within a storage device, such that each of the independently and uniquely addressable registers are addressable by a corresponding virtual address of the virtual address mapping without boundary limitations of the at least two distance sensing units when the reconfigurable predetermined detection window spans across the at least two distance sensing units.

18. The computer program product of claim 17, wherein the at least two distance sensing units are positioned adjacent to each other.

19. The computer program product of claim 17, wherein the operations comprise:
upon receiving an instruction to monitor a reconfigurable detection window, retrieve the virtual address mapping from the storage device;
identify a virtual address uniquely corresponding to the reconfigurable predetermined detection window based on the virtual address mapping; and,
monitor only the range of independently and uniquely addressable registers such that computational resources for monitoring the reconfigurable detection window are reduced.

20. The computer program product of claim 17, wherein the operations comprise,
upon receiving a detection signal from a register not within the reconfigurable detection window, transmit a signal to indicate a mispick.

21. The computer program product of claim 17, wherein the predetermined set of the independently and uniquely addressable registers comprise a user-selected range of adjacent distance sensing units such that only a portion of the independently and uniquely addressable registers are polled.

22. The computer program product of claim 17, wherein polling the predetermined set of the independently and uniquely addressable registers comprises polling on a Modbus.
